(19) United States
(12) Patent Application Publication
(10) Pub. No.: US 2026/0145913 A1
(43) Pub. Date: May 28, 2026

(54) ELEVATOR CAR COMPRISING A WORKING OPENING

(71) Applicant: Otis Elevator Company, Farmington, CT (US)

(72) Inventor: Arnaud Blanchard, Gien (FR)

(21) Appl. No.: 19/389,796

(22) Filed: Nov. 14, 2025

(30) Foreign Application Priority Data
Nov. 28, 2024 (EP) 24306997.8

(51) Int. Cl. B66B 11/02

(52) U.S. Cl. CPC B66B 11/0246; B66B 11/0206

(57) ABSTRACT

An elevator car includes a support frame that is provided at the top of the elevator car, the support frame includes at least two longitudinal beams extending basically parallel to each other in a longitudinal direction (L); and at least two transverse beams attached to the longitudinal beams and extending basically parallel to each other in a transverse direction (T) that is oriented transversely, in particular perpendicularly, to the longitudinal direction (L), such that the two of the least two longitudinal beams and the two of the least two transverse beams define a working opening having predefined transverse working opening dimensions (x, y) that are independent of the dimensions (A, B) of the elevator car, the working opening allowing a mechanic to access at least one component that is located above or on top of the elevator car from inside the elevator car.

### FOREIGN PRIORITY

This application claims priority to European Patent Application No. 24306997.8, filed Nov. 28, 2024, and all the benefits accruing therefrom under 35 U.S.C. § 119, the contents of which in its entirety are herein incorporated by reference.

### TECHNICAL FIELD OF INVENTION

The invention relates to an elevator car comprising a working opening, and to an elevator system comprising such an elevator car. The invention is further related to a method of accessing at least one component that is located above or on top of an elevator car from inside the elevator car through a working opening.

### BACKGROUND OF THE INVENTION

An elevator system typically comprises at least one elevator car that is configured for moving along a hoistway that extends between a plurality of landings.

A working opening may be provided at the top of the elevator car in order to allow a mechanic to access components that are located on top of or above the elevator car from inside the elevator car, for example for repair and/or maintenance. The elevator car may further include a working platform that allows the mechanic to stand on the working platform and to reach through the working opening. The sizes of the working opening and of the working platform vary depending on the size of the elevator car.

It would be beneficial to provide an improved elevator car comprising a working opening at the top of the elevator car that allows for manufacturing the elevator car more efficiently and at lower costs.

### SUMMARY OF THE INVENTION

An elevator car according to an exemplary embodiment of the invention has a longitudinal dimension in a longitudinal direction and a transverse dimension in a transverse direction that is oriented transversely, in particular perpendicularly, to the longitudinal direction. The longitudinal dimension and the transverse dimension define a horizontal area of the elevator car. The elevator car comprises at least two longitudinal beams extending basically parallel to each other in the longitudinal direction at the top of the elevator car and at least two transverse beams that are attached to the longitudinal beams and that extend basically parallel to each other in the transverse direction. Two of the least two longitudinal beams and two of the least two transverse beams define a working opening that allows a mechanic to access at least one component that is located above or on top of the elevator car from inside the elevator car. The working opening has a predefined longitudinal opening dimension and a predefined transverse working opening dimension defining an area of the working opening. In an elevator car according to an exemplary embodiment of the invention, at least one of the predefined longitudinal working opening dimension and the predefined transverse working opening dimension is independent of the respective longitudinal and transverse dimension of the elevator car.

The horizontal area of the elevator car that is defined by the longitudinal and transverse dimensions may correspond to the area of a floor and/or to the area of a ceiling of the elevator car.

Exemplary embodiments of the invention further include a plurality of elevator cars according to an exemplary embodiment of the invention including at least two elevator cars having different dimensions in the horizontal direction, wherein the longitudinal working opening dimensions of the working openings formed at the top of the elevator cars are identical for all of the plurality of elevator cars, and wherein the transverse working opening dimensions of the working openings formed at the top of the elevator cars are identical for all of the plurality of elevator cars.

Exemplary embodiments of the invention further include an elevator system comprising at least one elevator car according to an exemplary embodiment of the invention that is configured for traveling along a hoistway between a plurality of landings.

Exemplary embodiments of the invention also include a method of accessing at least one component that is located above or on top of an elevator car according to an exemplary embodiment of the invention. The method comprises moving a working platform from a storage position into a working position and accessing the at least one component located above or on top of an elevator car through the working opening that is provided at the top of the elevator car. The method includes in particular that a mechanic steps onto the working platform for reaching through the working opening formed at the top of the elevator car.

Exemplary embodiments of the invention allow for employing identical working platforms and identical working platform mechanisms that allow moving the working platform between a storage position and a working position in different elevator cars, in particular in elevator cars having different dimensions in the horizontal direction.

Identical working platforms and working platforms mechanisms may be manufactured cost-effectively in large numbers. Thus, employing identical working platforms and identical working platform mechanisms in a plurality of elevator cars may allow for reducing the costs of production of the working platforms, the working platform mechanisms and the elevator cars.

A number of further optional features are set out in the following. These features may be realized in particular embodiments, alone or in combination with any of the other features.

First and second of the at least two longitudinal beams may have a longitudinal dimension that depends on the longitudinal dimension of the elevator car. The first and second of the longitudinal beams may be arranged at a distance from each other that is independent of the transverse dimension of the elevator car and that corresponds to the transverse dimension of the working opening. The first and second transverse beams may extend between the first and second of the longitudinal beams.

Alternatively or additionally, first and second of the at least two transverse beams may have a transverse dimension that depends on the transverse dimension of the elevator car. The first and second transverse beams may be arranged at a distance from each other that is independent of the longitudinal dimension of the elevator car and that corresponds to the longitudinal dimension of the working opening. The first and second longitudinal beams may extend between the first and second transverse beams.

It is possible that at least one of the four beams defining the working opening is not part of an outer support frame that has basically the same dimensions in the horizontal direction as the elevator car. The horizontal dimensions of the working opening may in particular be smaller than the outer horizontal dimensions of the elevator car.

The elevator car may comprise a third longitudinal beam and/or at a third transverse beam such that two of the longitudinal beams and two transverse beams define the working opening. The third longitudinal beam may have a dimension that depends on the longitudinal dimension of the elevator car and/or the third transverse beam may have a dimension that depends on the transverse dimension of the elevator car.

The elevator car may further comprise a fourth longitudinal beam and/or a fourth transverse beam. The first and second longitudinal beams and the first and second transverse beams may define the working opening. The third and fourth longitudinal beams and/or the third and fourth transverse beams may have predefined dimensions that depend on the longitudinal dimensions and/or on the transverse dimensions of the elevator car.

The third and fourth longitudinal beams and the third and fourth transverse beams may form a ceiling frame surrounding a ceiling of the elevator car.

The third and fourth longitudinal beams and the third and fourth transverse beams may form a support frame that is provided at the top of the elevator car.

The third and fourth longitudinal beams may define an area at the top of the elevator car that corresponds to the horizontal area of the elevator car.

The first and second longitudinal beams may extend between the third and fourth transverse beams and the first and second transverse beams may extend between the first and second longitudinal beams, respectively.

Adding extra longitudinal and/or transverse beams to the support frame may result in a more stable structure at the top of the elevator car.

The working opening may be a rectangular opening having a first dimension in the range of between 600 mm and 800 mm and a second dimension in the range of between 700 mm and 900 mm.

The working opening may in particular have a first dimension of 680 mm and a second dimension of 788 mm. Alternatively, the working opening may have a first dimension of 700 mm and a second dimension of 900 mm, or a first dimension of 600 mm and a second dimension of 800 mm.

Such dimensions of the working opening have been found as beneficial for providing sufficient access to components that are located on top of and/or above the elevator car.

The at least two longitudinal beams may be stationary longitudinal beams that are not movable with respect to the elevator car. The stationary longitudinal beams may in particular be attached to stationary transverse beams provided at the top of the elevator car.

Alternatively or additionally, the two transverse beams may be stationary transverse beams that are attached to the two longitudinal beams in a configuration that does not allow the two transverse beams to move with respect to the two longitudinal beams.

Providing the longitudinal and/or transverse beams as stationary beams that are not movable with respect to the elevator car allows for providing a very stable support frame that may be manufactured at relatively low costs.

At least one of the longitudinal beams may be movable with respect to the transverse beams. The at least one of the longitudinal beams may in particular be movable along the first and second transverse beams.

The first and second transverse beams may comprise grooves extending along the length of the first and second transverse beams. The grooves may be configured to allow protrusions or rollers that are provided at end faces of the first and second longitudinal beams to move along said grooves in the transverse direction.

The transverse beams may be attached to the longitudinal beams in a configuration that allows the transverse beams to move with respect to the longitudinal beams.

At least two of the longitudinal beams may comprise grooves extending along their length that allow protrusions or rollers that are provided at the end faces of the first and second transverse beams to move along said grooves in the longitudinal direction.

The ability to move the longitudinal beams and/or the transverse beams allows for adjusting the position of the working opening in the horizontal direction. It may in particular allow for moving the working opening into a position in which it allows for conveniently accessing components that are arranged on the top of the elevator car and/or in the hoistway above the elevator car.

The elevator car may comprise a longitudinal beam locking mechanism that allows for selectively fixing the positions of the longitudinal beams with respect to the stationary beams. The elevator car may also comprise a transverse beam locking mechanism that allows for selectively fixing the positions of the transverse beams with respect to the longitudinal beams.

Providing the elevator car with at least one beam locking mechanism allows for preventing an undesired movement of the longitudinal beams and/or of the transverse beams after the desired position of the working opening has been set.

At least one of the beams may have a rectangular cross-section. Beams having a rectangular cross-section may have a large mechanic strength and they may be combined easily with each other for forming the support frame.

At least one of the beams may be a metallic profile, for example a metallic profile that is made of sheet metal. The metallic profile may, for example, be made of steel or of aluminum.

The elevator car may comprise a working platform that is movable between a storage position and a working position. When arranged in the storage position, the working platform may cover the working opening. When arranged in the working position, the working platform may allow a mechanic to access at least one component arranged above or on top of the elevator car through the working opening.

The working platform may in particular be configured for allowing a mechanic to stand on the working platform and to reach through the working opening, when the working platform is arranged in the working position. Providing an elevator car according to an exemplary embodiment of the invention with a movable working platform facilitates the access to components that are arranged on top of the elevator car and/or in the hoistway above the elevator car through the working opening. If the elevator car is equipped with a movable working platform, the mechanic does not need to carry a ladder or a mobile working platform to the elevator system for accessing components that are arranged on top of the elevator car and/or in the hoistway above the elevator car.

The working platform may be pivotable between the storage position and the working position. Alternatively, the elevator car may be equipped with a mechanism, in particular with a scissor mechanism, that allows for moving the working platform linearly between the storage position and the working position.

A foldable ladder may be attached to the working platform in order to allow the mechanic to climb onto the working platform more easily when the working platform is arranged in an elevated working position within the elevator car.

The elevator car may further comprise a movable decorative ceiling that allows for selectively covering the working opening and/or the working platform when the working platform is arranged in the storage position. The decorative ceiling may in particular be pivotable between a storage position, which covers the working opening, and an access position, which iallows access to the working opening.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts a perspective view of a working platform mechanism comprising a retractable working platform.

FIG. 3 depicts a perspective, partially sectional, view of an elevator car comprising a working platform mechanism.

FIG. 4 depicts a plan view of an adjustable support frame according to an exemplary embodiment of the invention.

FIG. 5 depicts a perspective view of the support frame depicted in FIG. 4.

FIG. 6 depicts a perspective view of a small elevator car having a working opening according to an exemplary embodiment of the invention.

FIG. 7 depicts a schematic view of the rectangular support frame employed in the elevator car depicted in FIG. 6.

FIGS. 8A to 8E depict schematic plan views of rectangular support frames according to exemplary embodiments of the invention, in which the working opening is located at different positions.

### DETAILED DESCRIPTION OF THE INVENTION

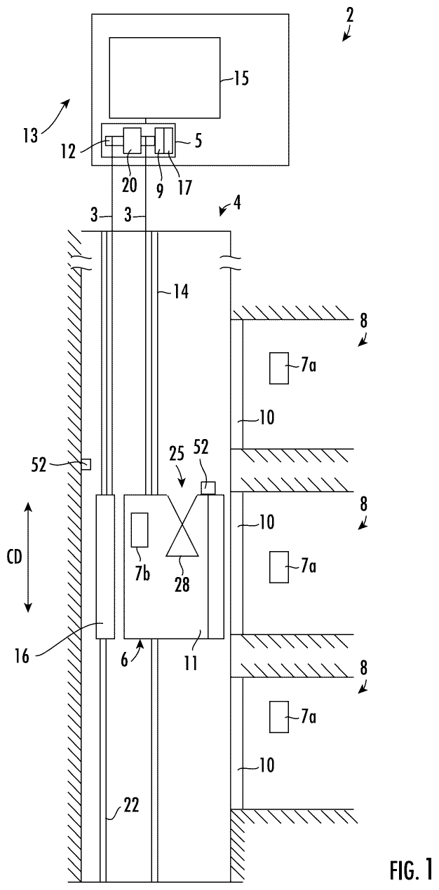

FIG. 1 schematically depicts an elevator system 2 according to an exemplary embodiment of the invention.

The elevator system 2 comprises a hoistway 4 extending in a conveying direction CD between a plurality of landings 8 located on different floors. The elevator system 2 includes an elevator car 6 that is arranged in the hoistway 4 for being moved along the conveying direction CD between the plurality of landings 8. The elevator car 6 may in particular be movable along at least one elevator car guide rail 14, provided in the hoistway 4 and extending along the conveying direction CD.

The conveying direction CD may be oriented in a vertical direction, as it is depicted in FIG. 1. In an alternative embodiment that is not depicted in the figures, the conveying direction CD may be inclined with respect to the vertical direction.

Although only a single elevator car guide rail 14 is depicted in FIG. 1, the elevator system 2 may comprise a plurality of elevator car guide rails 14 extending parallel to each other.

Although only a single elevator car 6 is depicted in FIG. 1, exemplary embodiments of the invention may also include elevator systems 2 comprising a plurality of elevator cars 6 moving in one or more hoistways 4.

The elevator car 6 is movably suspended by means of a tension member 3. Although only a single tension member 3 is depicted in FIG. 1, exemplary embodiments of the invention may also include elevator systems 2 comprising a plurality of tension members 3.

The at least one tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the at least one tension member 3, which is coupled to the shaft 12 via traction, in order to move the elevator car 6 in the hoistway 4 along the conveying direction CD between the plurality of landings 8.

The elevator drive system 5 is further provided with at least one elevator brake 20 for braking rotation of the shaft 12 in order to allow for stopping movement of the elevator car 6 and holding the elevator car 6 at a desired position in the hoistway 4.

Optionally, the elevator system 2 may comprise a counterweight 16. The counterweight 16 may be attached to the at least one tension member 3 opposite to the elevator car 6 and configured for moving concurrently and in opposite direction with respect to the elevator car 6. The counterweight may move along at least one counterweight guide rail 22, provided in the hoistway 4 and extending along the conveying direction CD.

The at least one tension member 3 may be a rope, e.g. a steel cord, or a belt, in particular a coated steel belt. The at least one tension member 3 may be uncoated. Alternatively, the at least one tension member 3 may be coated with a coating, e.g. with a coating having the form of a polymer jacket. In a particular embodiment, the at least one tension member 3 may be a belt comprising a plurality of polymer coated steel cords (not shown). The elevator system 2 may have a traction drive including a traction sheave for driving the at least one tension member 3.

In the exemplary embodiment shown in FIG. 1, a 1:1 roping is employed for suspending the elevator car 6. The type of the roping is, however, not essential for the invention and different kinds of roping, e.g. a 2:1 roping or a 4:1 roping may be employed as well.

A landing door 10 is provided at each of the landings 8. The elevator car 6 is provided with a corresponding elevator car door 11 for allowing passengers to transfer between a landing 8 and the interior of the elevator car 6, when the elevator car 6 is positioned at the respective landing 8.

For moving the elevator car 6 along the hoistway 4 between the different landings 8, the elevator drive system 5 may be controlled by an elevator controller 15 of the elevator system 2.

The elevator system 2 may be a machine room-less elevator system 2. In an alternative embodiment, the elevator system 2 may comprise a machine room 13 housing the elevator drive system 5 and the elevator controller 15.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

In order to allow a mechanic (not shown) to access components 52 of the elevator system 2 that are located on top of the elevator car 6 and/or in the hoistway 4 above the elevator car 6, a working opening 25 is provided in the ceiling of the elevator car 6.

The elevator car 6 may be equipped with a working platform 28 that may be arranged below the working opening 25 for supporting the mechanic in an elevated position in order to allow the mechanic to reach through the working opening 25 formed in the ceiling of the elevator car 6.

The working platform 28 may be a retractable working platform 28 that is movable between a working position for supporting a mechanic and a storage position.

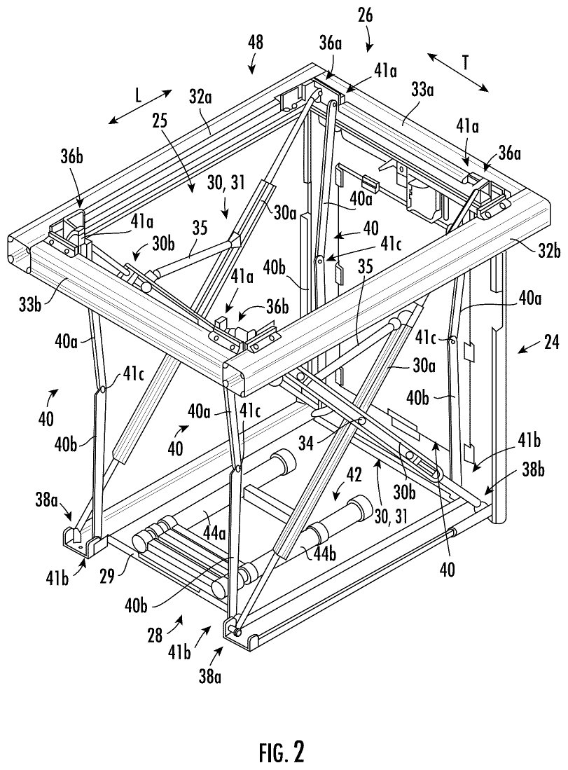

FIG. 2 depicts a perspective view of a working platform mechanism 26 comprising a retractable working platform 28.

The working platform mechanism 26 comprises a rectangular support frame 48 comprising four horizontally extending beams 32a, 32b, 33a, 33b including two longitudinal beams 32a, 32b extending in a longitudinal direction L, and two transverse beams 33a, 33b extending in a transverse direction T that is oriented perpendicularly to the longitudinal direction L. The support frame 48 defines a rectangular working opening 25.

A decorative ceiling 24 is pivotably attached to the support frame 48. The decorative ceiling 24 has basically the same shape and dimensions as the working opening 25 defined by the support frame 48.

The decorative ceiling 24 covers and closes said working opening 25 when the decorative ceiling 24 is arranged in a horizontal covering position, in which it is oriented horizontally parallel to the support frame 48.

The decorative ceiling 24 may be pivoted from the horizontal covering position, in which it extends basically parallel to the support frame 48, into a vertical access position, as it is depicted in FIG. 2, in which it extends basically parallel to the side walls of the elevator car 6 that are not depicted in FIG. 2.

When arranged in the access position, the decorative ceiling 24 allows accessing the working platform 28, which is movably attached to the support frame 48, from the interior of the elevator car 6.

The working platform 28 is movably attached to the support frame 48 by at least one support structure 31. In the embodiment depicted in FIG. 2, one support structure 31 is provided on each lateral side of the working platform 28, respectively.

In the exemplary embodiment depicted in FIG. 2, each support structure 31 comprises a scissor mechanism 30 including two scissor legs 30a, 30b extending diagonally between the working platform 28 and the support frame 48, respectively.

Each scissor leg 30a, 30b comprises an upper end pivotably connected to the support frame 48 by an upper scissor joint 36a, 36b, and a lower end pivotably connected to the working platform 28 by a lower scissor joint 38a, 38b.

A first scissor leg 30a extends between a lower scissor joint 38a mounted to a front portion of the working platform 28 shown on the left side of FIG. 2 and an upper scissor joint 36a mounted to a rear portion of the support frame 48 shown on the right side of FIG. 2. Correspondingly, a second scissor leg 30b extends between a lower scissor joint 38b mounted to a rear portion of the working platform 28 shown on the right side of FIG. 2 and an upper scissor joint 36b mounted to a front portion of the support frame 48 shown on the left side of FIG. 2.

In consequence, the first and second scissor legs 30a, 30b cross each other in central portions located between the first and second ends of the scissor legs 30a, 30b. The crossing central portions are pivotably connected with each other by central scissor joints 34. The central scissor joints 34 in particular are arranged halfway between the first and second ends of the respective scissor leg 30a, 30b, respectively.

The support structures 31 allow for moving the working platform 28 vertically between the retracted storage position and the deployed working position depicted in FIG. 2. When the working platform 28 is moved, i.e. raised or lowered, the scissor legs 30a, 30b pivot at the upper and lower scissor joints 36a, 36b, 38a, 38b with respect to the support frame 48 and with respect to the working platform 28, respectively. The two scissor legs 30a, 30b of each support structure 31 also pivot with respect to each other at the central scissor joints 34.

The length of each of the scissor legs 30a, 30b is variable. This allows adjusting the lengths of the scissor legs 30a, 30b to the varying distances between the upper and lower scissor joint 38a, 38b when moving the working platform 28.

Each support structure 31 further comprises a gas spring element 35 extending between the scissor legs 30a, 30b of the respective scissor mechanism 30.

In the exemplary embodiment depicted in FIG. 2, the gas spring elements 35 extend basically horizontally between the scissor legs 30a, 30b above the central scissor joints 34. Alternatively or additionally, gas spring elements 35 (not shown) extending basically horizontally between the scissor legs 30a, 30b below the central scissor joints 34 may be provided. Although not shown in the figures, gas spring elements 35 extending basically vertically between the scissor legs 30a, 30b on the right side and/or on the left side of the central scissor joints 34 may be provided as well.

The gas spring elements 35 are configured for damping the movement of the scissor legs 30a, 30b when the working platform 28 is lowered from its retracted storage position to its deployed working position. The gas spring elements 35 are further configured for supporting the movement of the working platform 28 when it is raised from the deployed working position into the retracted storage position. For mechanically stabilizing the working platform 28, in particular when it is arranged in the deployed working position, the elevator car 6 further comprises at least one stabilizer mechanism 40 extending between the support frame 48 and the working platform 28.

In the embodiment depicted in FIG. 2, four stabilizer mechanisms 40 are provided. In particular, one stabilizer mechanism 40 is provided at each of the four corners of the working platform 28 having a rectangular shape.

Each stabilizer mechanism 40 comprises a first stabilizer leg 40a and a second stabilizer leg 40b. An upper end of each first stabilizer leg 40a is pivotably mounted to the support frame 48 by an upper stabilizer joint 41a, and a lower end of the second stabilizer leg 40b is pivotably mounted to the working platform 28 by a lower stabilizer joint 41b.

Opposing second ends of the first and second stabilizer legs 40a, 40b facing each other are pivotably connected with each other by a central stabilizer joint 41c.

When the working platform 28 is arranged in the deployed working position as depicted in FIG. 2, the stabilizer legs 40a, 40b of each stabilizer mechanism 40 extend basically coaxially along a substantially vertical direction. In consequence, the stabilizer legs 40a, 40b of the four stabilizer mechanisms 40, the working platform 28 and the support frame 48 in combination form a basically rectangular cage. This increases the mechanical stability of the working platform 28 when arranged in the deployed working position. The central stabilizer joints 41c may be lockable in said position in order to increase the rigidity of said cage even further.

When the working platform 28 is moved from the deployed working position into the retracted storage position, the two stabilizer legs 40a, 40b pivot with respect to each other, with respect to the support frame 48 and with respect to the working platform 28, respectively. As a result, the stabilizer mechanisms 40 fold similar to the scissor mechanisms 30. This folding allows space-savingly storing the stabilizer mechanisms 40 with the stabilizer legs 40a, 40b oriented basically parallel to the working platform 28 and the support frame 48, when the working platform 28 is arranged in the retracted storage position.

In the exemplary configuration shown in FIG. 2, a ladder 42 is provided on the upper side of the working platform 28.

The ladder 42 in particular may be a telescopic ladder 42 comprising two telescopic bars 44a, 44b. The telescopic bars 44a, 44b may be compressed in order to allow storing the ladder 42 on the working platform 28 as depicted in FIG. 2.

When the working platform 28 is arranged in the deployed working position, the ladder 42 may be pivoted around a front edge 29 of the working platform 28, and the telescopic bars 44a, 44b may be expanded in order to extend the ladder 42 for bridging the distance between the floor of the elevator car 6 and the working platform 28 allowing a mechanic to easily climb onto the working platform 28.

In the exemplary embodiment of a working platform mechanism 26 depicted in FIG. 2, the working platform 28 is linearly movable between its storage position and its working position.

In further exemplary embodiments that are not explicitly depicted in the figures, the working platform 28 may be pivotable between the storage position and the working position.

FIG. 3 depicts a perspective, partially sectional, view of an elevator car 6 comprising a working platform mechanism 26 as it is depicted in FIG. 2 with the working platform 28 being arranged in the deployed working position and a mechanic 50 standing on said working platform 28.

Depending on the desired capacity of the elevator system 2 and the space that is available for the elevator system 2, the size of the elevator car 6, in particular the longitudinal and transverse dimensions of the elevator car 6, may vary.

For economic reasons, it may be beneficial to employ identical working platform mechanisms 26 in a plurality of elevator cars 6, including elevator cars 6 that have different horizontal dimensions.

This goal may be achieved by providing the support frame 48 as an adjustable support frame 48 that may be adjusted to different horizontal dimensions of the elevator car 6.

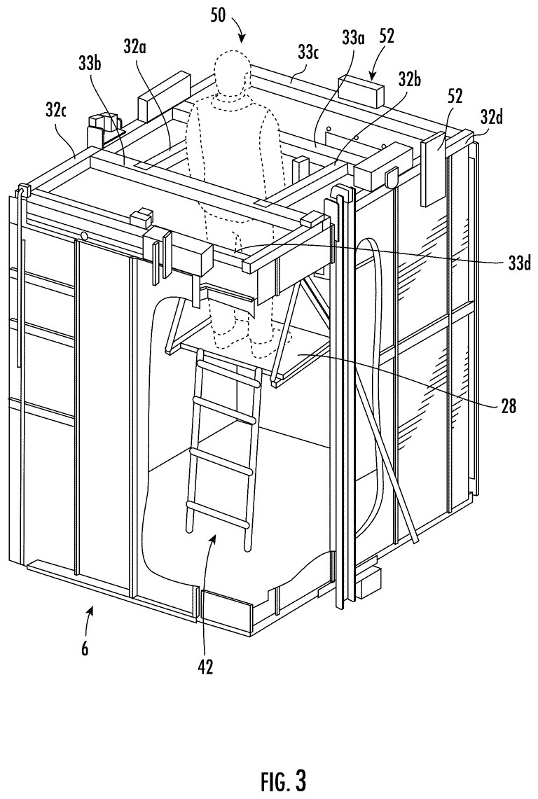

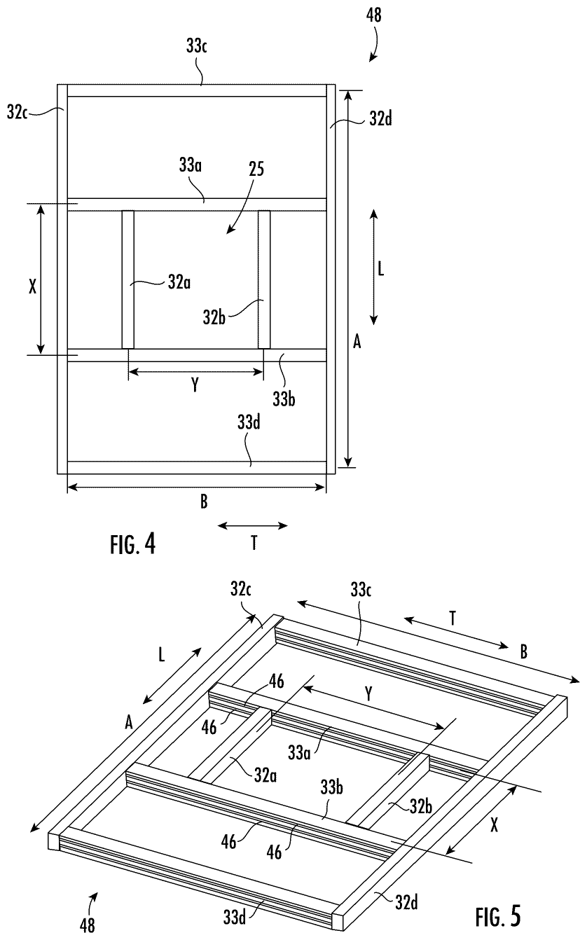

FIG. 4 depicts a plan view of an adjustable support frame 48 according to an exemplary embodiment of the invention. FIG. 5 depicts a perspective view of the support frame 48 depicted in FIG. 4.

In the exemplary embodiment depicted in FIGS. 4 and 5, the adjustable support frame 48 comprises four longitudinal beams 32a-32d extending basically parallel to each other in a longitudinal direction L of the adjustable support frame 48, and four transverse beams 33a-33d attached to the longitudinal beams 32a-32d and extending basically parallel to each other in a transverse direction T that is oriented transversely, in particular perpendicularly, to the longitudinal direction L.

The two innermost longitudinal beams 32a, 32b and the two innermost transverse beams 33a, 33b define the working opening 25 that allows the mechanic 50, which is not shown in FIGS. 4 and 5, to reach through from inside the elevator car 6.

The two longitudinal beams 32a, 32b and the two transverse beams 33a, 3b defining the working opening 25 are arranged such that the working opening 25 has predefined longitudinal and transverse working opening dimensions x, y that are independent of the longitudinal and transverse dimensions A, B of the elevator car 6.

Providing the elevator car 6 with a working opening 25 having predefined longitudinal and transverse working opening dimensions x, y that are independent of the outer dimensions A, B of the elevator car 6 allows for employing identical working platform mechanisms 26, for example working platform mechanisms 26 as depicted in FIG. 2, in a plurality of elevator cars 6 having different outer dimensions A, B.

Exemplary embodiments of the invention may further include a plurality of elevator cars 6 including elevator cars 6 that have different longitudinal and transverse dimensions A, B in the horizontal direction, wherein the predefined longitudinal and transverse working opening dimensions x, y of the working openings 25 that are formed in the ceilings of these elevator cars 6 are identical for all elevator cars 6 despite their different longitudinal and transverse dimensions A, B.

As a result, identical working platform mechanisms 26 may be manufactured and installed in a large number of different elevator cars 6 and elevator systems 2. This may allow for reducing the costs for producing the working platform mechanisms 26 and, in consequence, the costs for manufacturing of the elevator cars 6.

The working opening 25 of the support frame 48 depicted in FIGS. 4 and 5 is a rectangular opening.

The working opening 25 may have a predefined longitudinal opening dimension x in the longitudinal direction L that is in the range of between 600 mm and 800 mm and a predefined transverse opening dimension y in the transverse direction T that is in the range of between 700 mm and 900 mm.

The working opening 25 may, for example, have a predefined longitudinal opening dimension x between 770 mm and 790 mm, in particular a predefined longitudinal opening dimension x of 788 mm, and a predefined transverse opening dimension y between 650 mm and 700 mm, in particular a predefined transverse opening dimension y of 680 mm.

In alternative embodiments, the working opening 25 may have a predefined longitudinal opening dimension x of 700 mm and a predefined transverse opening dimension y of 900 mm. The working opening 25 may also have a predefined longitudinal opening dimension x of 600 mm and a predefined transverse opening dimension y of 800 mm.

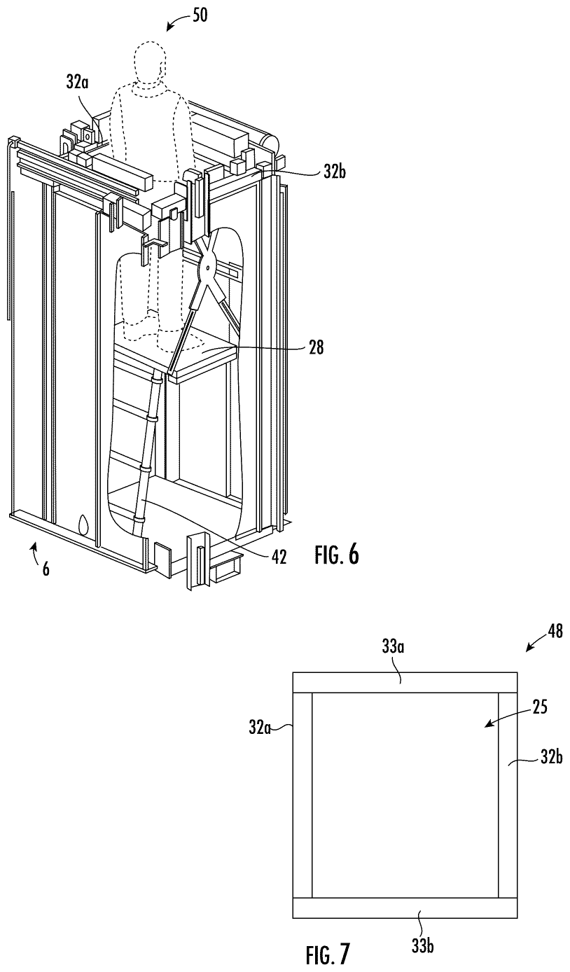

FIG. 6 depicts a perspective view of an elevator car 6 that is smaller than the elevator car 6 depicted in FIG. 3 and that has a working opening 25 according to an exemplary embodiment of the invention. FIG. 7 depicts a schematic view of the rectangular support frame 48 that is employed in said elevator car 6.

Due to the smaller size of the elevator car 6 in the horizontal directions, the rectangular support frame 48 of the elevator car 6 depicted in FIGS. 6 and 7 comprises only two longitudinal beams 32a, 32b and two transverse beams 33a, 33b that define a working opening 25 having the predefined longitudinal and transverse opening dimensions x, y.

In case the longitudinal and transverse dimensions A, B of the elevator car 6 are larger than the predefined longitudinal and transverse opening dimensions x, y of the working opening 25, as in the exemplary embodiment depicted in FIG. 3, the horizontal position of the working opening 25 in the ceiling of the elevator car 6 may be varied by varying the positions of the first and second longitudinal beams 32a, 32b and by varying the positions of the first and second transverse beams 33a, 33b.

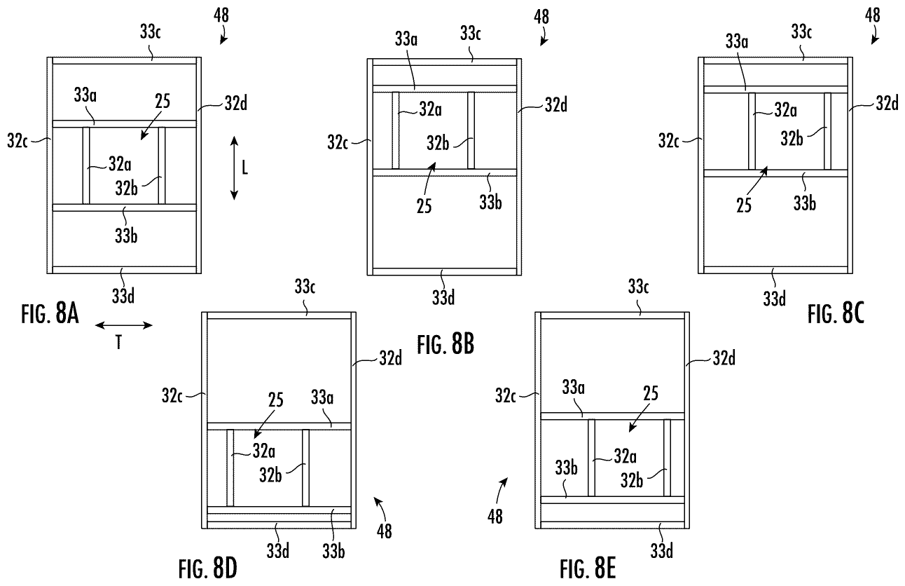

FIGS. 8A to 8E depict schematic plan views of rectangular support frames 48 according to several exemplary embodiments of the invention, in which the working opening 25 is located at different positions.

The position of the working opening 25 along the longitudinal direction L is defined by the positions of the first and second transverse beams 33a, 33b along the longitudinal direction L. The first and second transverse beams 33a, 33b are in particular attached to and supported by third and fourth longitudinal beams 32c, 32d that are arranged at the ends of the first and second transverse beams 33a, 33b and that extend along the longitudinal direction L.

The position of the working opening 25 along the transverse direction T is defined by the positions of the first and second longitudinal beams 32a, 32b along the transverse direction T. The first and second longitudinal beams 32a, 32b are attached to and supported by the first and second transverse beams 33a, 33b that are arranged at the ends of the first and second longitudinal beams 32a, 32b and that extend along the transverse direction T.

The rectangular support frames 48 depicted in FIGS. 4, 5, and 8A to 8E further comprise third and fourth transverse beams 33c, 33d extending between the ends of the third and fourth longitudinal beams 32c, 32d in the transverse direction T.

The third and fourth longitudinal beams 32c, 32d and the third and fourth transverse beams 33c, 33d form a support frame 48 of the working platform mechanism 26 that has basically the same longitudinal and transverse dimensions A, B in the horizontal plane as the elevator car 6.

In the embodiments depicted in FIGS. 4, 5, and 8A to 8E, each of the beams 32a-32d, 33a-33d has a rectangular cross-section, respectively. The beams 32a-32d, 33a-33d may, for example, be metallic profiles, in particular metallic profiles that are made of sheet metal, such as aluminum.

In the exemplary embodiments depicted in FIGS. 4, 5, and 8A to 8E, the support frames comprise eight beams 32a-32d, 33a-33d including four longitudinal beams 32a-32d and four transverse beams 33a-33d.

Support frames 48 according to further exemplary embodiments of the invention that are not explicitly depicted in the figures may comprise additional longitudinal beams and/or additional transverse beams. Providing the support frame 48 with additional beams may increase the stability and rigidity of the support frame 48.

Support frames 48 according to further exemplary embodiments of the invention may also comprise less than eight beams 32a-32d, 33a-33d, for example only four beams 32a, 32b, 33a, 33b, as in the embodiment depicted in FIGS. 6 and 7. Support frames 48 according to exemplary embodiments of the invention that are not explicitly shown in the figures may also comprise five or six beams.

The first and second longitudinal beams 32a, 32b may be stationary beams that are not movable with respect to the elevator car 6. The first and second longitudinal beams 32a, 32b may in particular be rigidly mounted to the first and second transverse beams 33a, 33b so that they are not movable with respect to the first and second transverse beams 33a, 33b along the transverse direction T.

Alternatively or additionally, the first and second transverse beams 33a, 33b may be stationary beams that are not movable with respect to the elevator car 6. The first and second transverse beams 33a, 33b may in particular be rigidly mounted to third and fourth longitudinal beams 32c, 32d so that they are not movable with respect to the third and fourth longitudinal beams 32c, 32d along the longitudinal direction L.

In a configuration in which the beams 32a, 32b, 33a, 33b are stationary, the position of the working opening 25 is permanently set during the manufacturing of the elevator car 6 by selecting the horizontal positions of the first and second longitudinal beams 32a, 32b and of the first and second transverse beams 33a, 33b in the support frame 48 formed at the top of the elevator car 6.

In an alternative embodiment, the first and second longitudinal beams 32a, 32b may be movable with respect to the elevator car 6. The first and second longitudinal beams 32a, 32b may in particular be movable along the first and second transverse beams 33a, 33b in the transverse direction T. Such a configuration allows for adjusting the position of the working opening 25 in the transverse direction T by moving the first and second longitudinal beams 32a, 32b in the transverse direction T.

The first and second transverse beams 33a, 33b may, for example, comprise grooves 46 (see FIG. 5) extending along the length of the first and second transverse beams 33a, 33b that allow protrusions or rollers (not shown) provided at the end faces of the first and second longitudinal beams 32a, 32b to move along said grooves 46 in the transverse direction T.

The first and second transverse beams 33a, 33b and/or the first and second longitudinal beams 32a, 32b may comprise at least one locking mechanism (not shown) that allows for selectively fixing and locking the first and second longitudinal beams 32a, 32b with respect to the first and second transverse beams 33a, 33b at the desired positions.

Additionally or alternatively, the first and second transverse beams 33a, 33b may be movable with respect to the elevator car 6. The first and second transverse beams 33a, 33b may in particular be movable along the third and fourth longitudinal beams 32c, 32d in the longitudinal direction L. Such a configuration allows for changing the position of the working opening 25 in the longitudinal direction L by moving the first and second longitudinal beams 32a, 32b in the longitudinal direction L.

The third and fourth longitudinal beams 32c, 32d may comprise grooves 46 (see FIG. 5) extending along their length that allow protrusions or rollers (not shown) provided at the end faces of the first and second transverse beams 33a, 33b to move along said grooves 46 in the longitudinal direction L.

The first and second transverse beams 33a, 33b and/or the third and fourth longitudinal beams 32c, 32d may comprise at least one locking mechanism (not shown) that allows for selectively fixing and locking the first and second transverse beams 33a, 33b with respect to the third and fourth longitudinal beams 32c, 32d at desired positions.

The ability to adjust the position of the working opening 25 in the longitudinal L direction and/or in the transverse direction T may allow for configuring the support frame 48 in a configuration that allows the mechanic 50 to reach and access components 52 that are located on top of the elevator car 6 and/or components 52 that are located at the walls of the hoistway 4 above the elevator car 6 more easily and/or more conveniently, in particular in case the elevator car 6 has large longitudinal and transverse dimensions A, B.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator car (6) having a longitudinal dimension (A) in a longitudinal direction (L) and a transverse dimension (B) in a transverse direction (T) that is oriented transversely, in particular perpendicularly, to the longitudinal direction (L) defining a horizontal area of the elevator car (6), the elevator car (6) comprising:
at least two longitudinal beams (32a-32d) extending basically parallel to each other in the longitudinal direction (L) at the top of the elevator car (6); and
at least two transverse beams (33a-33d) attached to the longitudinal beams (32a-32d) and extending basically parallel to each other in the transverse direction (T), such that;
two of the least two longitudinal beams (32a-32d) and two of the least two transverse beams (33a-33d) define a working opening (25) allowing a mechanic (50) to access at least one component (52) that is located above or on top of the elevator car (6) from inside the elevator car (6);
wherein the working opening (25) has a predefined longitudinal opening dimension (x) and a predefined transverse working opening dimension (y) defining an area of the working opening (25), and wherein at least one of the longitudinal and transverse working opening dimensions (x, y) is independent of the respective longitudinal and transverse dimension (A, B) of the elevator car (6).

2. Elevator car (6) according to claim 1,
wherein first and second longitudinal beams (32a, 32b) of the at least two longitudinal beams (32a-32d) defining the working opening (25) have a longitudinal dimension (x) that depends on the longitudinal dimension (A) of the elevator car (6) and are arranged at a distance from each other that is independent of the transverse dimension (B) of the elevator car (6) and that corresponds to the transverse working opening dimension (y), and wherein the first and second of the transverse beams (33a, 33b) extend between the first and second longitudinal beams (32a, 32b); and/or wherein first and second transverse beams (33a, 33b) of the at least two transverse beams (33a-33d) defining the working opening (25) have a transverse dimension (y) that depends on the transverse dimension (B) of the elevator car (6) and are arranged at a distance from each other that is independent of the longitudinal dimension (A) of the elevator car (6) and that corresponds to the longitudinal working opening dimension (x), and wherein the first and second longitudinal beams (32a, 32b) extend between the first and second of the transverse beams (33a, 33b);

3. Elevator car (6) according to claim 1, comprising a third longitudinal beam (32c) and/or a third transverse beam (33c), two of the longitudinal beams (32a-32d) and two of the transverse beams (33a-33d) defining the working opening (25), the third longitudinal beam (32c) having a dimension that depends on the longitudinal dimension (A) of the elevator car (6) and/or the third transverse beam (33c) having a dimension that depends on the transverse dimension (B) of the elevator car (6).

4. Elevator car (6) according to claim 3, comprising a fourth longitudinal beam (32d) and/or a fourth transverse beam (33d), the first and second of the longitudinal beams (32a, 32b) and the first and second of the transverse beams (33a, 33b) defining the working opening (25), and the third and fourth of the longitudinal beams (32c, 32d) and/or the third and fourth (33c, 33d) of the transverse beams (33a-33d) having predefined dimensions that depend on the longitudinal and/or transverse dimensions (A, B) of the elevator car (6).

5. Elevator car (6) according to claim 4, wherein the third and fourth of the longitudinal beams (32c, 32d) and the third and fourth of the transverse beams (33c, 33d) define an area corresponding to the horizontal area of the elevator car (6) and/or form a support frame (48) that is provided at the top of the elevator car (6).

6. Elevator car (6) according to claim 4, wherein the first and second of the longitudinal beams (32a, 32b) extend between the third and fourth transverse beams (33c, 33d) and the first and second transverse beams (33a, 33b) extend between the first and second of the longitudinal beams (32a, 32b).

7. Elevator car (6) according to claim 1,
wherein the working opening (25) is a rectangular opening having a predefined longitudinal opening dimension (x) in the range of between 600 mm and 800 mm and a predefined transverse opening dimension (y) in the range of between 700 mm and 900 mm,
wherein the working opening (25) has in particular a predefined longitudinal opening dimension (x) of 680 mm and a predefined transverse opening dimension (y) of 788 mm, or a predefined longitudinal opening dimension (x) of 700 mm and a predefined transverse opening dimension (y) of 900 mm, or a predefined longitudinal opening dimension (x) of 600 mm and a predefined transverse opening dimension (y) of 800 mm.

8. Elevator car (6) according to claim 1, wherein the at least two longitudinal beams (32a-32d) are stationary longitudinal beams (32a-32d) that are not movable with respect to the elevator car (6); wherein the stationary longitudinal beams (32a-32d) are in particular stationarily attached to two of the transverse beams (33a-33d).

9. Elevator car (6) according to claim 1,
wherein at least one of the longitudinal beams (32a-32d) is movable with respect to the transverse beams (33a-33d);
wherein the elevator car (6) comprises in particular a longitudinal beam locking mechanism that allows for selectively fixing the positions of the longitudinal beams (32a-32d) with respect to the transverse beams (33a-33d).

10. Elevator car (6) according to claim 1, wherein the two transverse beams (33a, 33b) are attached to the two longitudinal beams (32a, 32b) in a configuration that does not allow the two transverse beams (33a, 33b) to move with respect to the two longitudinal beams (32a, 32b).

11. Elevator car (6) according to claim 1,
wherein at least one of the transverse beams (33a-33d) is movable with respect to the longitudinal beams (32a-32d);
wherein the elevator car (6) comprises in particular a transverse beam locking mechanism that allows for selectively fixing the positions of the transverse beams (33a-33d) with respect to the longitudinal beams (32a-32d).

12. Elevator car (6) according to claim 1,
further comprising a working platform (28) that is movable between a storage position, in particular a storage position in which the working platform (28) covers the working opening (25), and a working position that allows the mechanic (50) to access at least one component (52) arranged above or on top of the elevator car (6) through the working opening (25);
wherein the working platform (28) is in particular configured such that it allows a mechanic (50) to stand on the working platform (28) and to reach through the working opening (25) when the working platform (28) is arranged in the working position;
wherein the working platform (28) is pivotable between the storage position and the working position, or wherein the elevator car (6) comprises a mechanism (30), in particular a scissor mechanism (30), that allows for moving the working platform (28) linearly between the storage position and the working position;
wherein the elevator car (6) in particular further comprises:
a foldable ladder (40) attached to the working platform (28); and/or a pivotable decorative ceiling (24) that allows for selectively covering the working opening (25) and/or the working platform (28) when it is arranged in the storage position.

13. Elevator system (2) comprising at least one elevator car (6) according to claim 1 that is configured for traveling along a hoistway (4) between a plurality of landings (8).

14. A plurality of elevator cars (6) according to claim 1 including at least two elevator cars (6) having different longitudinal and transverse dimensions (A, B) in the horizontal direction, wherein the longitudinal working opening dimensions (x) of the working openings (25) formed at the top of the elevator cars (6) are identical for all of the plurality of elevator cars (6), and wherein the transverse working opening dimensions (y) of the working openings (25) formed at the top of the elevator cars (6) are identical for all of the plurality of elevator cars (6 ).

15. Method of accessing at least one component (52) located above or on top of an elevator car (6) according to claim 9, wherein the method comprises moving the working platform (28) from the storage position into the working position and accessing the at least one component (52) located above or on top of an elevator car (6) though the working opening (25) that is defined by the first and transverse beams (33a-33d); wherein the method includes in particular stepping onto the working platform (28) for reaching through the working opening (25).
